(19) United States
(12) Patent Application Publication
(10) Pub. No.: US 2013/0192774 A1
(43) Pub. Date: Aug. 1, 2013

(54) SAFETY WINDOW BLIND DEVICE

(71) Applicant: Shih-Ming Lin, Chiayi Hsien (TW)

(72) Inventor: Shih-Ming Lin, Chiayi Hsien (TW)

(21) Appl. No.: 13/361,560

(22) Filed: Jan. 30, 2012

(51) Int. Cl. E06B 9/24

(52) U.S. Cl. 160/340

(57) ABSTRACT

A safety window blind device includes a bottomrail movable relative to a headrail to raise or lower a window shade therebetween, and a pair of lifting cords each having a vertical cord segment which runs between the headrail and the bottomrail and which is coupled with the bottom rail so as to be displaced therewith between states of long-length and short-length. A reel unit is coupled with a biasing unit to generate an incrementally increased biasing force for counteracting the weight of the bottomrail. With such structure, a sudden and inadvertent falling of the bottomrail can be prevented once the lifting cords are released.

### BACKGROUND OF THE INVENTION

1. Field of the Invention

This invention relates to a window blind device, more particularly to a safety window blind device having a cord-held bottomrail.

2. Description of the Related Art

Referring to FIG. 1, a conventional window blind as disclosed in U.S. Pat. No. 6,802,356 B2 is shown to include a headrail 11, a bottomrail 12, and a slat unit 13 disposed between the headrail 11 and the bottomrail 12. The slat unit 13 includes a plurality of parallel slats 131, a pair of pulleys 132 mounted in the headrail 11, a cord lock 133, and a pair of lifting cords 10. Each of the lifting cords 10 travels through the cord lock 133, the headrail 11, the respective pulley 132, the slats 131, and the bottomrail 12. Lower ends 103 of the lifting cords 10 exiting from the bottomrail 12 are affixed to a fixed object, such as a wall so as to dispose the lifting cords 10 in a tensed state. By manually operating the bottomrail 12, the bottomrail 12 can be raised or lowered and be positioned in place through frictional engagement between the lifting cords 10 and the bottomrail 12. As the lower ends 103 of the lifting cords 10 are affixed onto a wall, swaying movement of the bottomrail 12 and the slat unit 13 due to wind and risks of strangulation can be avoided.

However, since operation and positioning of the bottomrail 12 are controlled according to the tensile force of the lifting cords 10 which is adjustable by releasing the cord lock 133, the bottomrail 12 may drop suddenly and inadvertently by virtue of its own weight if the tensile force is not sufficient or the cord lock 133 is operated to unlock the lifting cords 10 during a tension adjusting operation.

### SUMMARY OF THE INVENTION

An object of the present invention is to provide a safety window blind device which can be operated safely and smoothly.

According to this invention, the safety window blind device includes a headrail having a pair of first direction-turning regions which are spaced apart from each other in a longitudinal direction, a bottomrail having a pair of second direction-turning regions which are mated with the first direction-turning regions, respectively, and disposed to be movable relative to the headrail in an upright direction, a window shade having an upper end which is connected to the headrail, and a lower end which is connected to the bottomrail so as to be moved therewith, a pair of lifting cords, and a cord tensioning mechanism. Each of the lifting cords has an initial cord segment which is located in and extends out of the headrail, a terminal cord segment which is located in and led out of the bottomrail, and a vertical cord segment which is interposed between the initial and terminal cord segments, and which runs between respective ones of the first and second direction-turning regions so as to be displaced from a state of long length to a state of short length when the bottomrail is moved from a lower position to an upper position. The cord tensioning mechanism is disposed to keep the vertical cord segment in a tensed state when the vertical cord segment is running between the corresponding ones of the first and second direction-turning regions.

The safety window blind device further includes a reel unit and a biasing unit. The reel unit includes a reel member pivotally mounted on the headrail about a reel axis, and a positioning cord having a reelable cord segment wound on the reel member, and extending to terminate at a leading end which is connected with the bottomrail such that the reelable cord segment is moved upward from a drawn-out position to a drawn-in position synchronously with the displacement of the vertical cord segment from the long-length state to the short-length state. The biasing unit is configured to have a biasing force to counteract the weight of the bottomrail such that, in response to the movement of the reelable cord segment from the drawn-in position to the drawn-out position, the biasing force of the biasing unit is incrementally increased so as to bias the reelable cord segment toward the drawn-in position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a sectional schematic view of a conventional window blind disclosed in U.S. Pat. No. 6,802,356 B2;

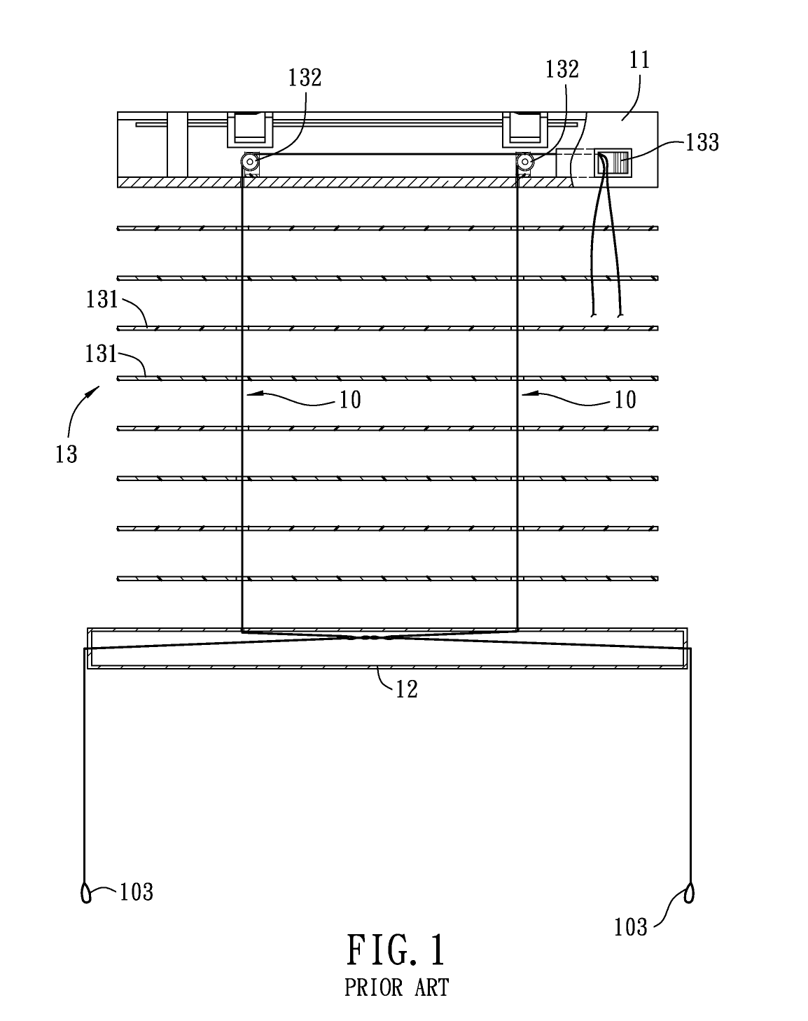

FIG. 2 is a perspective view of the preferred embodiment of a safety window blind device according to this invention;

FIG. 3 is a sectional schematic view of the preferred embodiment; and

FIG. 4 is a fragmentary exploded perspective view of a weight-counteracting mechanism of the preferred embodiment.

### DETAILED DESCRIPTION OF THE PREFERRED EMBODIMENT

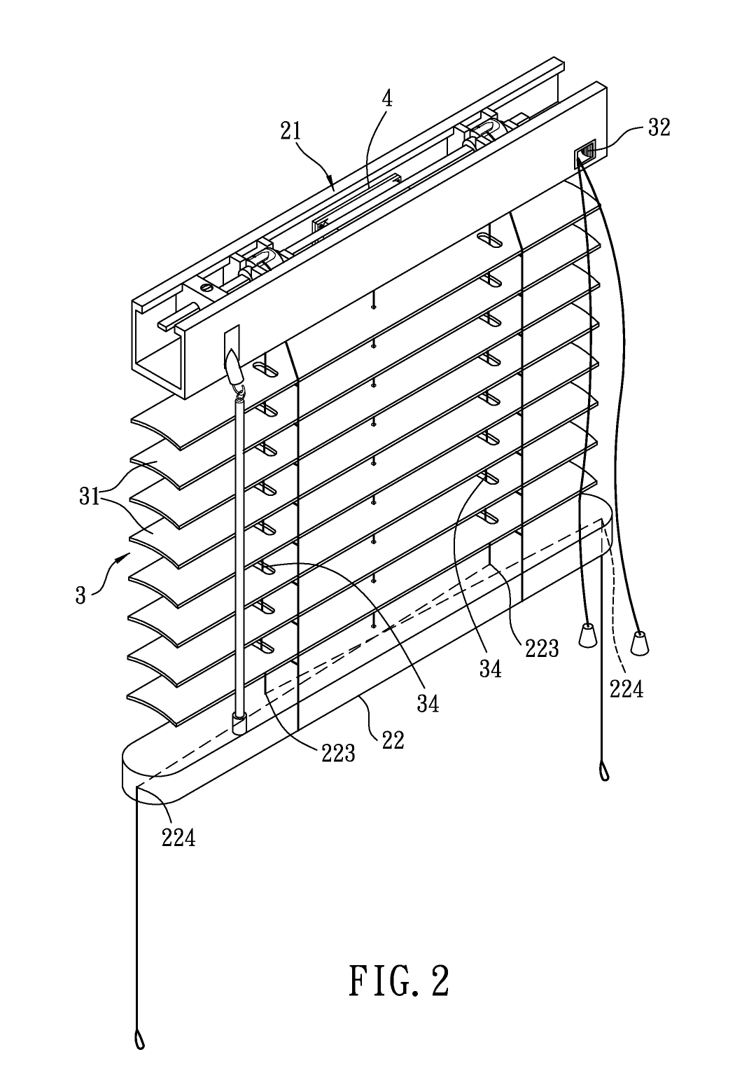

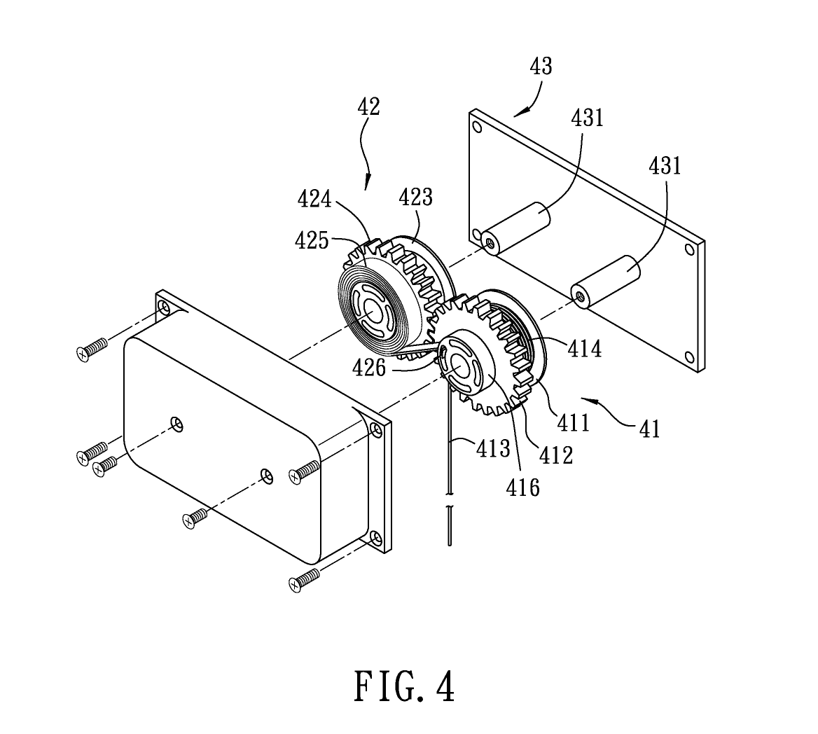

Referring to FIGS. 2 to 4, the preferred embodiment of a safety window blind device according to the present invention is shown to comprise a headrail 21 adapted to be mounted on an upper sill of a window (not shown), a bottomrail 22 disposed to be movable relative to the headrail 21 in an upright direction, a window shade 3 having an upper end connected to the headrail 21, and a lower end connected to the bottomrail 22 so as to be moved therewith, a pair of lifting cords 34, a cord tensioning mechanism 32, and a weight-counteracting mechanism 4.

The headrail 21 has a pair of first direction-turning regions 211 spaced apart from each other in a longitudinal direction to have a pair of pulley wheels 33 pivotably mounted thereon, respectively. The bottomrail 22 has a pair of second direction-turning regions which are in the form of through holes 223 and which are aligned with the first direction-turning regions 211, respectively, in the upright direction. The bottomrail 22 further has a pair of lateral holes 224 at two lateral sides thereof .

In this embodiment, the window shade 3 includes a plurality of parallel slats 31. Alternatively, the window shade 3 may be formed as a pleated shade with a plurality of pleats interconnecting the slats 31.

Each of the lifting cords 34 has an initial cord segment 343 which is located in and extends out of the headrail 21, a terminal cord segment 342 which is located in and led out of the bottomrail 22 through the respective lateral hole 224, and a vertical cord segment 341 which is interposed between the initial and terminal cord segments 343, 342, and which is guided and runs between the respective pulley wheel 33 and the through hole 223 and through the slats 31 so as to be displaced from a state of long length to a state of short length when the bottomrail 22 is moved from a lower position to an upper position.

The cord tensioning mechanism 32 is disposed on the headrail 21 to releasably lock the initial cord segments 343 so as to be operable to keep the vertical cord segments 341 in a tensed state when the vertical cord segments 341 are running between the corresponding pulley wheels 33 and the through holes 223. Since the cord tensioning mechanism 32 is of a hitherto known type, a description thereof is dispensed with herein for the sake of brevity.

The weight-counteracting mechanism 4 includes a housing 43, and a reel unit 41 and a biasing unit 42 which are accommodated in the housing 43. The housing 43 is disposed on the headrail 21 between the first direction-turning regions 211, and has a pair of shafts 431 disposed in the housing 43 to define a reel axis and a winding axis, respectively. The reel unit 41 includes a reel member 411 which is pivotally mounted on the shaft 431 to be rotatable about the reel axis, a meshing gear 412 which is coaxially rotatable with the reel member 411, and a positioning cord 413 which has a reelable cord segment 414 wound on the reel member 411, and which extends in the upright direction to terminate at a leading end 415 that is connected with the bottomrail 22. The biasing unit 42 includes a winding hub 423 which is pivotally mounted on the shaft 431 to be rotatable about the winding axis, a flat coil spring 425 which is wound around the winding hub 423 to have an angular biasing force, and which has a fixed end 426 connected to a reel hub 416 of the reel member 411, and a meshed gear 424 which is coaxially rotated with the winding hub 423 and which is meshed with the meshing gear 412.

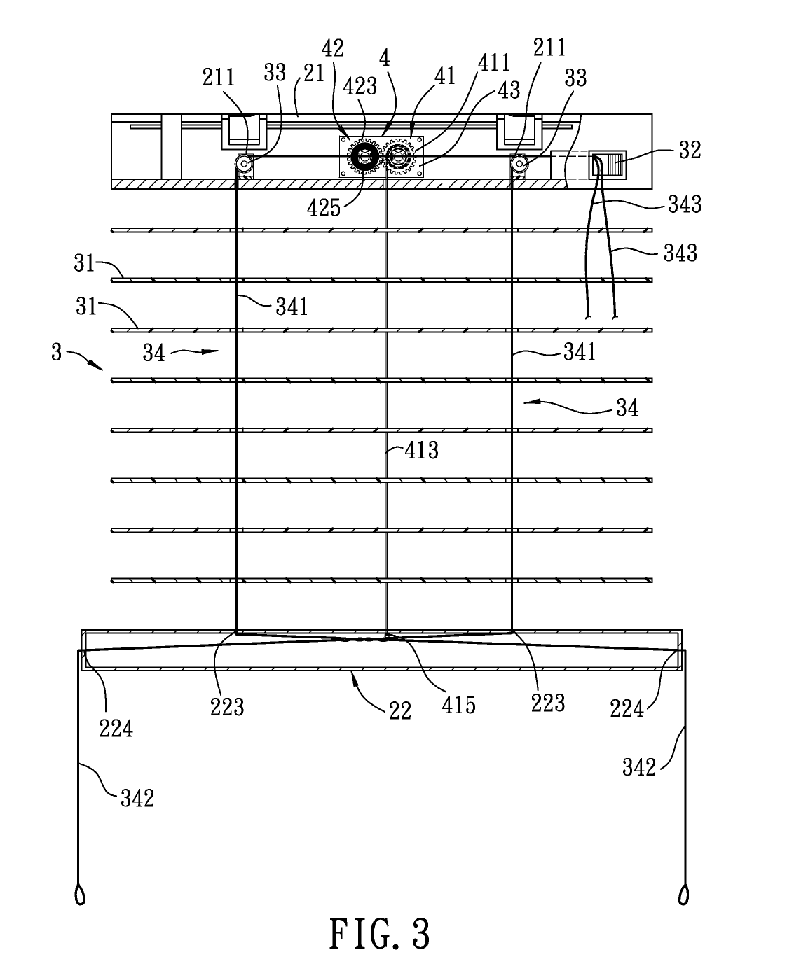

The angular biasing force of the flat coil spring 425 is dimensioned depending on the weight of the bottomrail 22 and the window shade 3. The tensile force of the lifting cords 34 (i.e., in correspondence with the length of the vertical cord segments 341) can be adjusted by means of the cord tensioning mechanism 32. When the bottomrail 22 is displaced to a lowermost position (as shown in FIG. 3) synchronously with the displacement of the vertical cord segments 341 from the short-length state to the long-length state, the reel member 411 is rotated with the movement of the positioning cord 413 to the drawn-out position such that the flat coil spring 425 is wound off the winding hub 423 and reeled on the reel hub 416 by virtue of the mesh engagement between the gears 424, 412. Thereby, the angular biasing force of the flat coil spring 425 is incrementally increased so as to bias the positioning cord 413 upwardly toward the drawn-in position. By the frictional engagement between the bottomrail 22 and the lifting cords 34, and by the angular biasing force of the flat coil spring 425, the bottomrail 22 is easily and smoothly pushed upwards to the upper position.

When it is desired to adjust the tensile force of the lifting cords 34 to unlock the initial cord segments 343 by operating the cord tensioning mechanism 32, the angular biasing force of the flat coil spring 425 can counteract the weight of the bottomrail 22 and the slats 31 so as to slow down the downward movement of the bottomrail 22. Hence, sudden and inadvertent falling of the bottomrail 22 can be avoided.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A safety window blind device comprising:
a headrail having a pair of first direction-turning regions which are spaced apart from each other in a longitudinal direction;
a bottomrail having a pair of second direction-turning regions which are mated with said first direction-turning regions, respectively, said bottomrail being disposed to be movable relative to said headrail in an upright direction;
a window shade having an upper end connected to said headrail, and a lower end connected to said bottomrail so as to be moved therewith;
a pair of lifting cords, each having an initial cord segment which is located in and extends out of said headrail, a terminal cord segment which is located in and led out of said bottomrail, and a vertical cord segment which is interposed between said initial and terminal cord segments, and which runs between respective ones of said first and second direction-turning regions so as to be displaced from a state of long length to a state of short length when said bottomrail is moved from a lower position to an upper position;
a cord tensioning mechanism disposed to keep said vertical cord segment in a tensed state when said vertical cord segment is running between the corresponding ones of said first and second direction-turning regions;
a reel unit including a reel member which is pivotally mounted on said headrail about a reel axis, and a positioning cord having a reelable cord segment wound on said reel member, and extending to terminate at a leading end which is connected with said bottomrail such that said reelable cord segment is moved upward from a drawn-out position to a drawn-in position synchronously with the displacement of said vertical cord segment from the long-length state to the short-length state; and
a biasing unit configured to have a biasing force to counteract weight of said bottomrail such that, in response to the movement of said reelable cord segment from the drawn-in position to the drawn-out position, the biasing force of said biasing unit is incrementally increased so as to bias said reelable cord segment toward the drawn-in position.

2. The safety window blind device as claimed in claim 1, wherein the biasing force is an angular biasing force.

3. The safety window blind device as claimed in claim 2, wherein said reel unit has a meshing gear which is coaxially rotatable with said reel member, said biasing unit having a flat coil spring which is wound around a winding axis so as to have the angular biasing force, and a meshed gear which is coaxially rotated with said flat coil spring, and which is meshed with said meshing gear so as to permit the angular biasing force to be transmitted to said reel member.

4. The safety window blind as claimed in claim 3, further comprising a housing disposed on said headrail for accommodating said reel unit and said biasing unit, and a pair of shafts disposed in said housing to define the reel and winding axes, respectively.

5. The safety window blind as claimed in claim 1, further comprising a pair of pulley wheels pivotably mounted on said headrail at said first direction-turning regions, respectively, for guiding said lifting cords to run thereon, said bottomrail having a pair of through holes at said second direction-turning regions, respectively, for extension of said lifting cords thereinto to form said terminal cord segments.
